(19) United States
(12) Patent Application Publication
(10) Pub. No.: US 2008/0061201 A1
(43) Pub. Date: Mar. 13, 2008

(54) Paint can and paintbrush holder attachment for ladders

(75) Inventor: James R. Sasser, Louisville, GA (US)

Correspondence Address: MONAHAN & MOSES, LLC, 13-B W. WASHINGTON ST., GREENVILLE, SC, 29601, US

(73) Assignee: SCS Products, LLC, Smyrna, GA (US)

(21) Appl. No.: 11/507,244

(22) Filed: Aug. 21, 2006

(51) Int. Cl. E06C 7/14

(52) U.S. Cl. 248/210

(57) ABSTRACT

A paint can and paintbrush holder attachment includes, in a first embodiment, a main body shaft member having a slidable clamp positioned near a first end and a fixed clamp positioned near a second end of the main body shaft member. At either end of the main body shaft member is a threaded fitting. A circular ring used to hold and support a can of paint includes a threaded fitting that may be coupled with the threaded fittings on either end of the main body shaft. The circular ring also includes a paintbrush holder clamp for receiving a paintbrush holder. The paintbrush holder, in a preferred embodiment, is a rigid rod bent generally into an L shape, and having a notch near a free end thereof for use in hanging a paintbrush therefrom. The paintbrush holder may be attached to the circular ring using the paintbrush holder clamp in such a way that the paintbrush may be hung directly over the paint can, allowing dripped paint to fall back into the paint can. Alternatively, the main body shaft member may be formed into a telescopic configuration, allowing the length of the main body shaft member to be extended or reduced to fit a variety of ladder and scaffolding sizes and shapes.

### BACKGROUND OF THE INVENTION

1. Field of the Invention

The present invention relates to ladder attachments and accessories used to secure a paint can or pail to a ladder. More specifically, the present invention relates to a paint can and paintbrush holder that may be removably attached to a ladder or scaffolding at any desired level.

2. Description of the Prior Art

Paint can holders are known in the prior art. Known prior art includes the following: U.S. Pat. Nos.: 1,256,909; 2,907,541; 3,857,537; 3,979,097; 3,987,993; 4,032,100; 4,139,173;4,266,746; 4,433,822; 4,569,449; 4,824,060; 5,542,553; 5,649,682; 6,024,192; and 6,076,636. Each of the devices described in the above patents has certain disadvantages, including difficulty and expense in manufacturing and lack of flexibility of use, among other problems. Therefore, it can be appreciated that a need exists for an improved paint can and paintbrush holder attachment that is relatively simple and inexpensive to manufacture, may be used on ladders and scaffolding of different sizes and shapes, and avoids other disadvantages of the above-mentioned devices.

### SUMMARY OF THE INVENTION

In view of the foregoing disadvantages inherent in the known types of paint can holders present in the prior art, it is an object of the present invention to provide an improved paint can and paintbrush holder attachment that includes the advantages of the prior art while avoiding the disadvantages. The general purpose of the present invention is to provide a paint can and paintbrush holder that may be secured to a user's ladder or scaffolding of various shapes and sizes.

The paint can and paintbrush holder attachment of the present invention includes, in a first embodiment, a main body shaft member having a slidable clamp positioned near a first end and a fixed clamp positioned near a second end of the main body shaft member. At either end of the main body shaft member is a threaded fitting. A circular ring used to hold a can of paint includes a threaded fitting that may be coupled with the threaded fittings on either end of the main body shaft. The circular ring also includes a paintbrush holder clamp for receiving a paintbrush holder. The paintbrush holder, in a preferred embodiment, is a rigid rod bent generally into an L shape, and having a notch near a free end thereof for use in hanging a paintbrush therefrom. The paintbrush holder may be attached to the circular ring using the paintbrush holder clamp in such a way that the paintbrush may be hung directly over the paint can, allowing dripped paint to fall back into the paint can.

### BRIEF DESCRIPTION OF THE DRAWINGS

These and other features, aspects, and advantages of the present invention will become better understood with regard to the following description, appended claims, and accompanying drawings where:

FIG. 1 is a top view of a paint can holder attachment for a ladder having a main body shaft member, a pair of clamps for attachment to a ladder, a circular ring member for securing a paint can thereto, and a removable paintbrush holder;

FIG. 2 is an exploded view of a paint can holder attachment for a ladder;

FIG. 3 is a side view of a paint can holder attachment for a ladder; and

FIG. 4 is a side view of a paint can holder attachment for a ladder, illustrated as attached to a ladder with a paintbrush hanging from the paintbrush holder directly over the paint can.

### DETAILED DESCRIPTION OF THE INVENTION

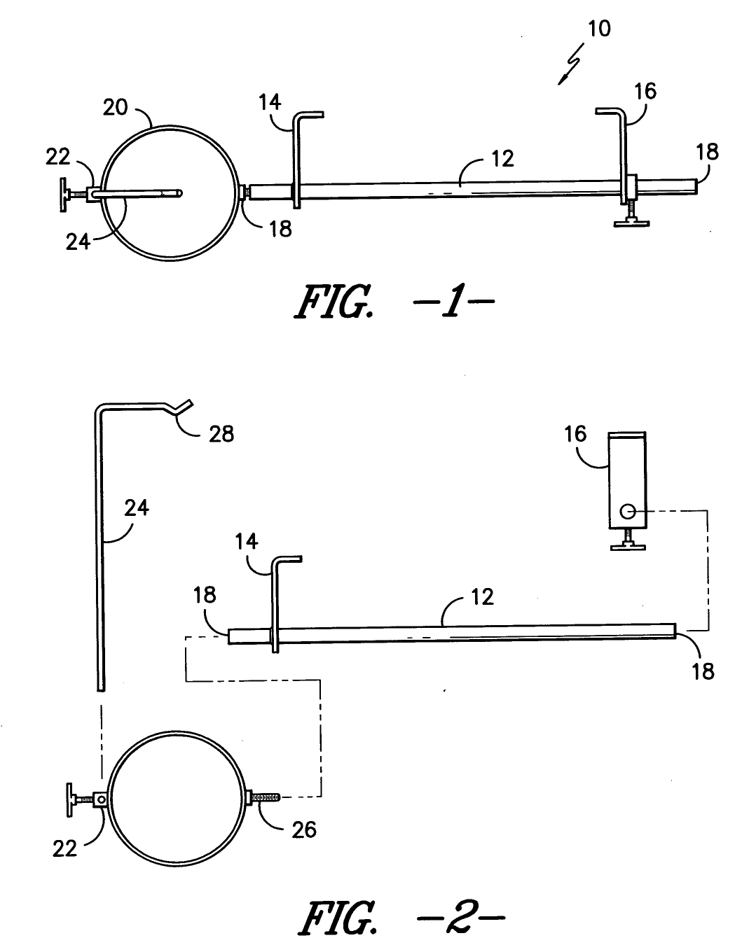

A first embodiment of the paint can and paintbrush holder attachment 10 is shown in FIG. 1. The paint can and paintbrush holder attachment 10 includes a main body shaft member 12 having a slidable clamp 16 positioned near a first end and a fixed clamp 14 positioned near a second end of the main body shaft member. At either end of the main body shaft member is a threaded fitting 18. A circular ring 20 used to hold a can of paint includes a threaded fitting 26 that may be coupled with the threaded fittings 18 on either end of the main body shaft 12. The circular ring 20 also includes a paintbrush holder clamp 22 for receiving a paintbrush holder 24. The paintbrush holder 24, in a preferred embodiment, is a rigid rod bent generally into an L shape, and having a notch 28 near a free end thereof for use in hanging a paintbrush therefrom. The paintbrush holder 24 may be attached to the circular ring 20 using the paintbrush holder clamp 22 in such a way that the paintbrush may be hung directly over the paint can, allowing dripped paint to fall back into the paint can.

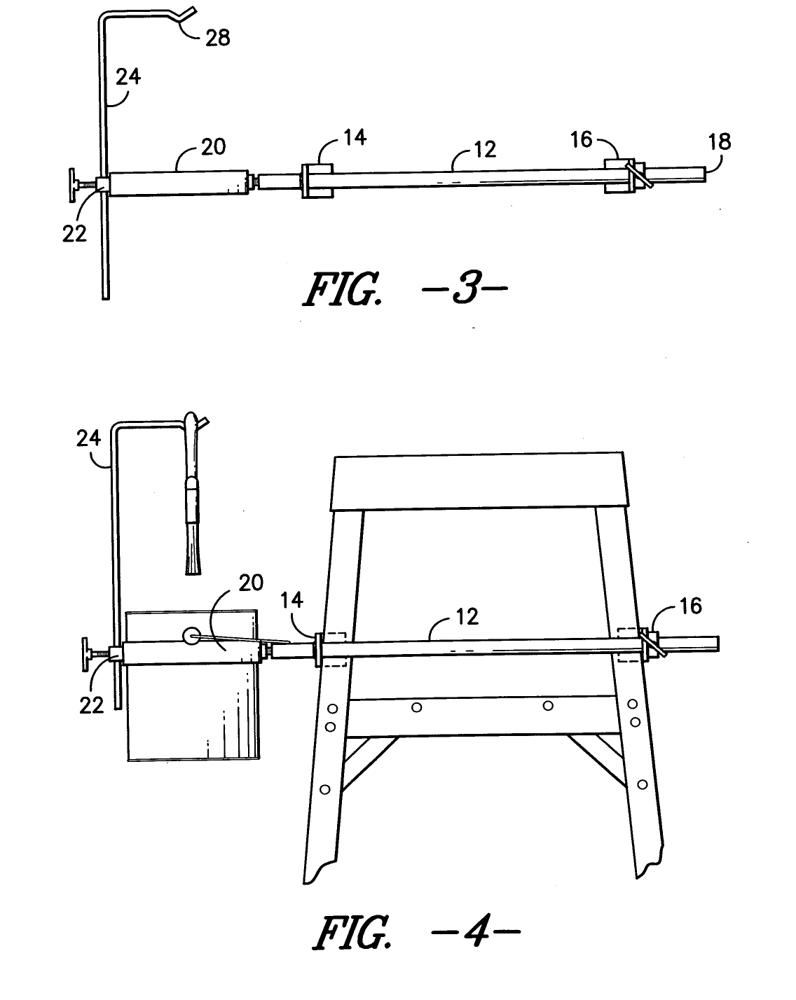

FIG. 2 shows an exploded view of one embodiment of the paint can and paintbrush holder attachment 10. In this embodiment, the fixed clamp 14 is integrally formed onto the main body shaft member 12, and either end of the main body shaft member includes a threaded fitting 18 for receiving the circular ring member 20. The slidable clamp 16 is positioned on an opposed end from the fixed clamp 14. In a preferred embodiment, the slidable clamp 16 is released so that it is free to slide along the length of the main body shaft 12 when a user is attaching the holder attachment to a ladder or scaffolding. After the user has positioned the main body shaft 12 so that the clamps 14, 16 are disposed on either side of a ladder or scaffolding, the user may then slide the slidable clamp 16 inwardly to tightly engage the rails of the ladder, and then may tighten the slidable clamp 16 to secure the apparatus in place, as shown in FIG. 4. The slidable clamp 16, in a preferred embodiment, includes a hole through which the main body shaft member 12 slides and a threaded fitting to receive a threaded bolt for securing the slidable clamp 16 in place with respect to the main body shaft member 12. It is to be understood that the clamps may alternatively face outwardly instead of inwardly, so that they engage the inside of each ladder rail rather than the outside of the rail. It is also to be understood that the slidable clamp 16 may be of any suitable configuration, so long as it may be slid into position along the main body shaft member 12 and secured thereto.

Having threaded fittings 18 on both ends of the main body shaft 12 allows the ring member 20 to be attached to either end of the main body shaft member 12, for convenience of the user. Alternatively, a circular ring member 20 may be placed on both ends of the main body shaft member 12, thus allowing two different cans of paint to be secured thereto. If a painter is using two different color paints, for instance one color for a wall and another color for trim around a door, window or ceiling molding, it is advantageous to have the two different colored paint cans within easy access of the painter who is positioned on a ladder.

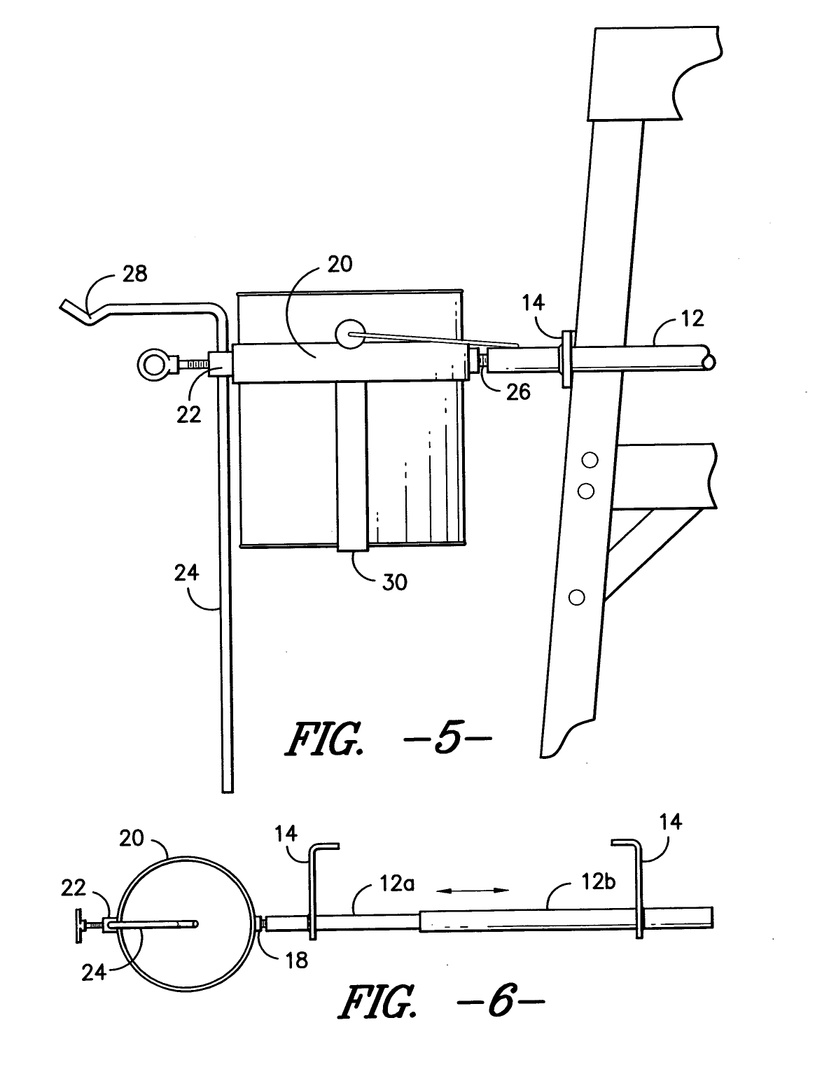

As shown in FIGS. 2, 3 and 4, the paintbrush holder 24, in a preferred embodiment, is a rigid rod formed into an L shape, and having a paintbrush notch 28 adjacent a free end thereof for attachment of a paintbrush thereto. The paintbrush holder is slidably affixed to the circular ring 20 by a paintbrush holder clamp 22, which includes a hole through which the paintbrush holder slides and a threaded fitting to receive a threaded bolt for securing the paintbrush holder in place. The paintbrush holder may be secured to any desired height above the paint can for the convenience of the user, and may be positioned so that the paintbrush is held over the paint can, or in any position in a 360 degree arc about the longitudinal axis of the rod.

The entire paint can and paintbrush holder attachment may be made from metal (for instance, steel, aluminum, iron) or any other suitable material, so long as it is rigid enough and strong enough to support a standard size paint can full of paint. In an alternate embodiment, both clamps disposed on the main body shaft member may be in slidable relation therewith, and it should be understood that other types of clamp members or fasteners may be employed to removably affix the apparatus to specific objects, such as scaffolding and the like. The circular ring member may be of a standard size to snugly fit a standard sized paint can, or may be adjustable to fit different sizes of paint cans. The circular ring may also, in another embodiment, include a support structure 30 that extends downwardly and beneath the paint can (similarly to commonly used beverage holders in automobiles and boats) to provide additional support as shown in FIG. 5. The support structure in this embodiment is shown in FIG. 5, and allows smaller cans or containers of paint to be held and supported by the circular ring. Furthermore, instead of a circular ring member being used to support a can of paint, other types and shapes of support structures may be used, including a square support member for paint containers having a generally square configuration or shape.

In another alternate embodiment, the main body shaft member may be formed into a telescopic configuration as shown in FIG. 6, so that the main body shaft 12a, 12b may be shortened or lengthened to fit various sizes of ladders, scaffolds and the like. As will be appreciated by one skilled in the art of telescoping devices, the length may be infinitely adjustable into any desired length, or may be incrementally adjustable into two or more set positions. With respect to the telescoping main body shaft 12a, 12b having infinite adjustability, the clamps at either free end thereof may be fixed, and may face outwardly or inwardly. In this infinitely adjustable configuration, the main body shaft 12a, 12b may be lengthened so that the clamps 14 are disposed on the outside of the ladder rails, for instance, and then adjusted inwardly and locked into position. For the incrementally adjustable telescopic embodiment, one of the two clamps may be in slidable relation to the main body shaft member. These telescoping embodiments allow a user to shorten the main body member for storage purposes, when the apparatus is not in use.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A paint can holder comprising:
a main body shaft member having a fixed clamp formed integrally thereon for removable attachment to a ladder or scaffolding;
a slidable clamp member that is in slidable relation with said main body shaft member, wherein said slidable clamp member may be secured at any desired point along said main body shaft member, and wherein said slidable clamp member may be used for removable attachment to a ladder or scaffolding; and
a first paint can support member attached to one end of said main body shaft member for receiving and supporting a can or container of paint.

2. The paint can holder set forth in claim 1, further comprising a paintbrush holder attached to said paint can support member.

3. The paint can holder set forth in claim 2, wherein said paintbrush holder is formed from a rigid rod bent into a generally L shape.

4. The paint can holder set forth in claim 2, wherein said paintbrush holder is positioned so that a paintbrush secured thereto is located directly above said paint can support member, thus allowing paint dripped from said paintbrush to fall into a paint can supported thereby.

5. The paint can holder set forth in claim 2, wherein said paintbrush holder is removably attached to said paint can support member by a clamp that allows a paintbrush to be positioned at any desired height above said paint can support member.

6. The paint can holder set forth in claim 1, wherein said main body shaft member is formed in a telescopic configuration, so that its length may be extended or reduced, thus allowing said paint can holder to be affixed to ladders or scaffolds of varying sizes, and further allowing said paint can holder to occupy a reduced amount of space for storage.

7. The paint can holder set forth in claim 1, further comprising a second paint can support member attached to an opposed end of said main body shaft member from said first paint can support member.

8. The paint can holder set forth in claim 1, wherein said paint can support member is in the form of a circular ring.

9. A method for attaching a paint container to a ladder or scaffolding, said method comprising the steps of;
providing a main body shaft member having a paint can support member attached thereto;
providing at least one slidable clamp member that is in slidable relation with said main body shaft member, and which may be affixed at any desired point along said main body shaft member;
providing at least one fixed clamp member, integrally formed with said main body shaft member; and
attaching said slidable clamp and said fixed clamp to vertical support members of a ladder or scaffolding.

10. The method set forth in claim 9, further comprising the additional step of providing a paintbrush holder attached to said paint can support member.

11. The method set forth in claim 10, further comprising the additional step of positioning said paintbrush holder so that a paintbrush secured thereto is located directly above said paint can support member, thus allowing paint dripped from said paintbrush to fall into a paint can supported thereby.

12. A paint can holder comprising:
a main body shaft member formed in a telescopic configuration, so that its length may be extended or reduced, and having a fixed clamp formed integrally thereon at either free end for removable attachment to a ladder or scaffolding; and
a first paint can support member attached to one end of said main body shaft member for receiving and supporting a can or container of paint.

13. The paint can holder set forth in claim 12, further comprising a paintbrush holder attached to said paint can support member.

14. The paint can holder set forth in claim 13, wherein said paintbrush holder is formed from a rigid rod bent into a generally L shape.

15. The paint can holder set forth in claim 13, wherein said paintbrush holder is positioned so that a paintbrush secured thereto is located directly above said paint can support member, thus allowing paint dripped from said paintbrush to fall into a paint can supported thereby.

16. The paint can holder set forth in claim 13, wherein said paintbrush holder is removably attached to said paint can support member by a clamp that allows a paintbrush to be positioned at any desired height above said paint can support member.

17. The paint can holder set forth in claim 12, further comprising a second paint can support member attached to an opposed end of said main body shaft member from said first paint can support member.

18. The paint can holder set forth in claim 12, wherein said paint can support member is in the form of a circular ring.
